(19) United States
(12) Patent Application Publication
(10) Pub. No.: US 2021/0051732 A1
(43) Pub. Date: Feb. 18, 2021

(54) METHOD AND APPARATUS FOR RANDOM ACCESS FALLBACK PROCEDURE RELATED TO MT EDT IN A WIRELESS COMMUNICATION SYSTEM

(71) Applicant: LG ELECTRONICS INC., Seoul (KR)

(72) Inventors: Hyunjung Choe, Seoul (KR); Seungjune Yi, Seoul (KR); Jeonggu Lee, Seoul (KR)

(73) Assignee: LG ELECTRONICS INC., Seoul (KR)

(21) Appl. No.: 16/993,545

(22) Filed: Aug. 14, 2020

(30) Foreign Application Priority Data
Aug. 14, 2019 (KR) 10-2019-0099701

(51) Int. Cl. H04W 74/08; H04W 76/30; H04W 68/00; H04B 17/318; H04W 8/22; H04L 12/24

(52) U.S. Cl. CPC H04W 74/0833; H04W 76/30; H04W 68/005; H04W 88/02; H04W 8/22; H04L 41/06; H04B 17/318

(57) ABSTRACT

A method and apparatus for random access fallback procedure related to MT EDT in a wireless communication system is provided. A wireless device receives, from the network, a paging including a dedicated random access (RA) resource corresponding to a first coverage enhancement (CE) level. A wireless device initiates a first RA attempt using the dedicated RA resource. A wireless device increases a CE level of the wireless device to a second CE level based on failure of the first RA attempt. A wireless device selects a non-dedicated RA resource corresponding the second CE level. A wireless device performs a second RA attempt using the non-dedicated RA resource.

### CROSS-REFERENCE TO RELATED APPLICATION

Pursuant to 35 U.S.C. § 119(a), this application claims the benefit of earlier filing date and right of priority to Korean Patent Application No. 10-2019-0099701, filed on Aug. 14, 2019, the contents of which are all hereby incorporated by reference herein in its entirety.

### TECHNICAL FIELD

The present disclosure relates to a method and apparatus for random access fallback procedure related to MT EDT in a wireless communication system.

### RELATED ART

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

In Rel-13, narrowband internet-of-things (NB-IoT) and LTE for machine-type communication (LTE-M) were standardized to provide wide-area connectivity for IoT. The technologies in Rel-14 evolved beyond the basic functionality specified in Rel-13. In Rel-15, to optimize the support for infrequent small data packet transmissions.

For internet-of-things (TOT) user equipment (UE) such as MTC UE and NB-IOT, there are high requirements on the life of battery. Power consumption of wireless device is a key improvement indicator. In the long term evolution (LTE) R-16, one technical requirement is to support uplink transmission in RRC idle mode so that the wireless device could save the power used to enter RRC connected mode.

### SUMMARY

A wireless device may receive downlink (DL) via RRC message during random access procedure. A wireless device may receive the DL data by mobile terminated (MT) early data transmission (EDT) procedure. For example, the DL data may be included in the second message (Message-2) in random access procedure. For other example, the DL data may be included in the fourth message (Message-4) in random access procedure. In Message-2 (Msg2) based MT EDT procedure, a wireless device may receive at least one dedicated random access (RA) resource via the paging message. The network may distinguish the wireless device by the dedicated RA resource, since the wireless device transmits an RA preamble using the dedicated RA resource.

The wireless device for MT EDT may transmit RA preamble by using the dedicated RA resource. Upon receiving the RA preamble based on the dedicated RA resource, the network may transmit DL user data to the wireless device via Msg2. However, the wireless device may not successfully transmit, to the network, the preamble.

Therefore, studies for random access fallback procedure related to MT EDT in a wireless communication system are required.

In an aspect, a method performed by a wireless device in a wireless communication system is provided. A wireless device receives, from the network, a paging including a dedicated random access (RA) resource corresponding to a first coverage enhancement (CE) level. A wireless device initiates a first RA attempt using the dedicated RA resource. A wireless device increases a CE level of the wireless device to a second CE level based on failure of the first RA attempt. A wireless device selects a non-dedicated RA resource corresponding the second CE level. A wireless device performs a second RA attempt using the non-dedicated RA resource.

In another aspect, an apparatus for implementing the above method is provided.

The present disclosure can have various advantageous effects.

According to some embodiments of the present disclosure, a wireless device could perform random access fallback procedure efficiently.

For example, a wireless device may save resource for random access fallback procedure, when a wireless device fails to transmit a preamble to the network while in message-2 based MT EDT procedure.

For example, a wireless device may save resource for supporting coverage enhancement (CE) mode by assigning one dedicated random access resource to the wireless device.

For example, a wireless device may increase reliability of MT EDT procedure by continuing the procedure using contention based random access procedure, when contention free random access procedure is not successful.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 shows an example of a method for random access fallback procedure related to MT EDT in a wireless communication system, according to some embodiments of the present disclosure.

FIG. 11 shows an example of a method for random access fallback procedure related to MT EDT in a wireless communication system, according to some embodiments of the present disclosure.

FIG. 12 shows a diagram of a method for random access fallback procedure related to MT EDT in a wireless communication system, according to some embodiments of the present disclosure.

### DESCRIPTION OF EXEMPLARY EMBODIMENTS

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDDCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

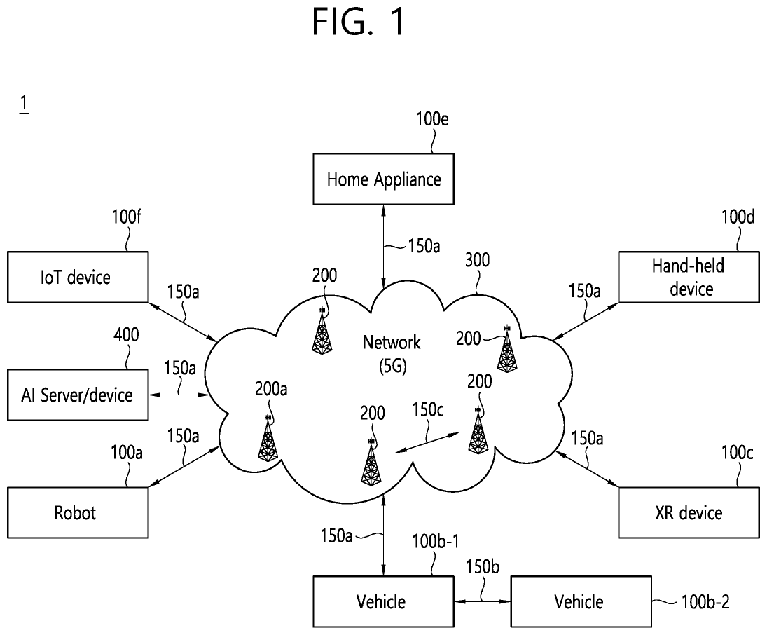

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5GNR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

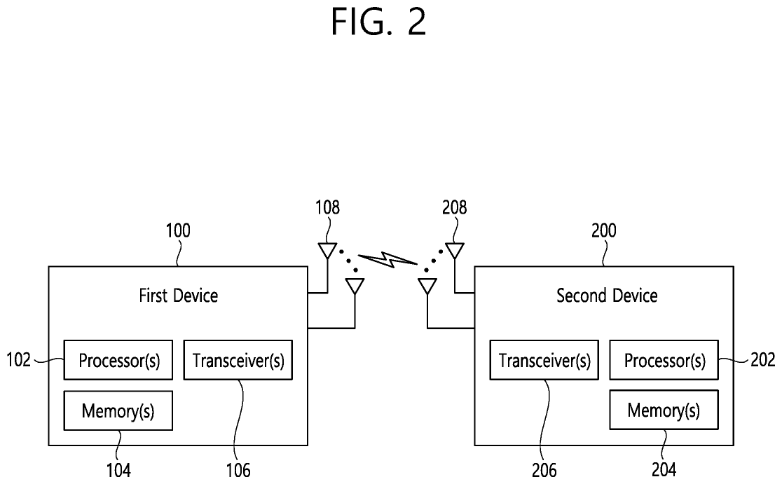

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108.

Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. Descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

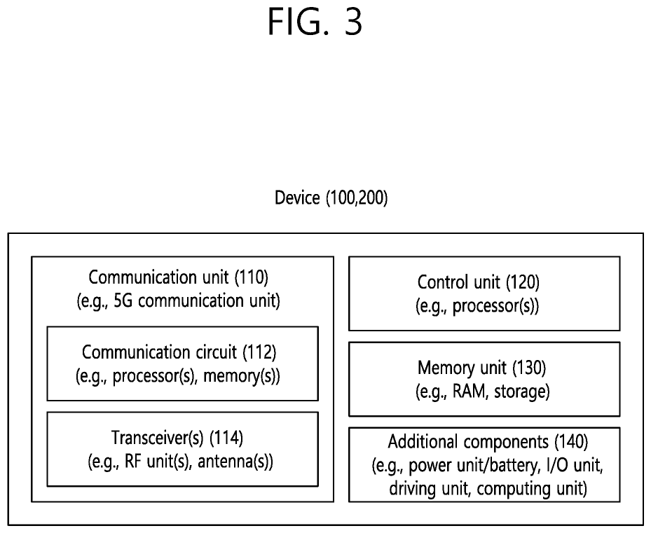

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

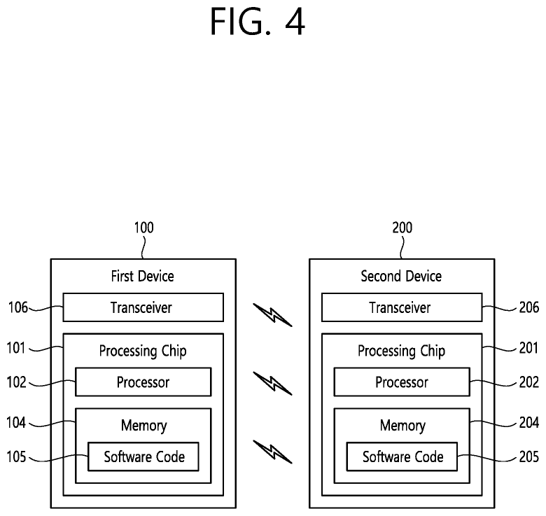

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

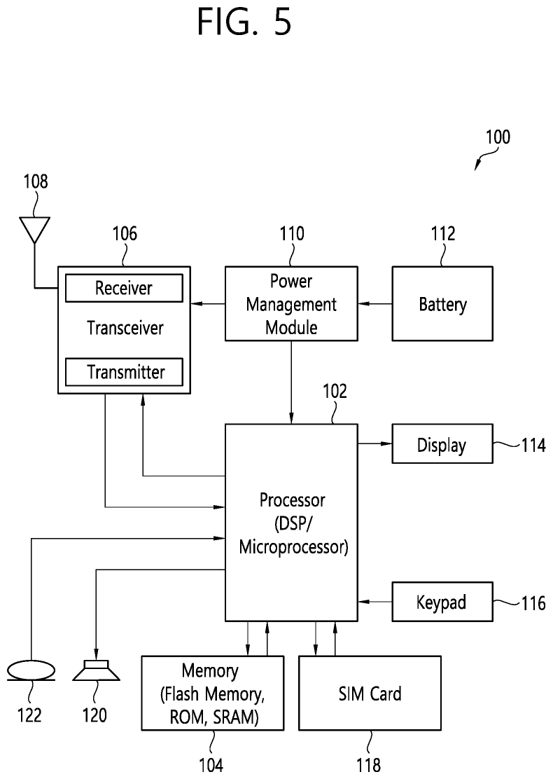

FIG. 5 shows an example of UE to which implementations of the present disclosure is applied. Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

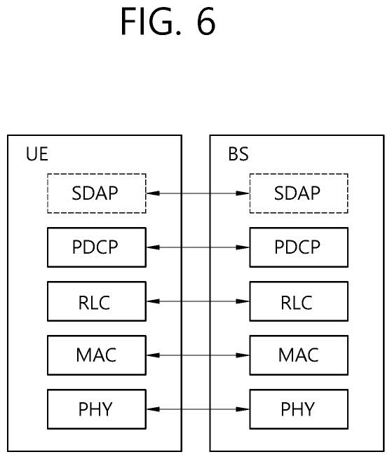

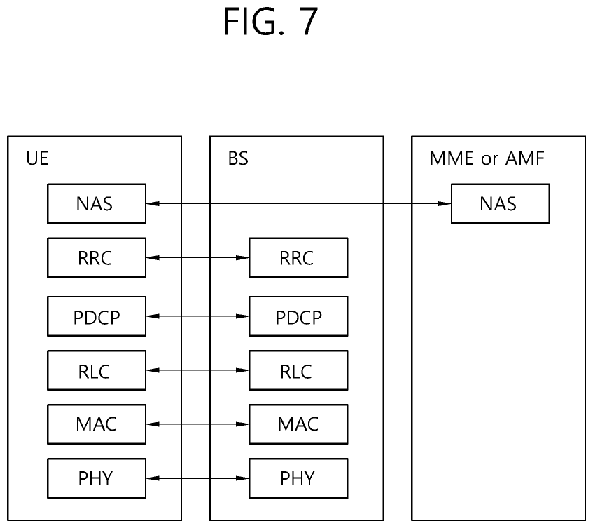

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PHY layer) and Layer 2. Referring to FIG. 7, the control plane protocol stack may be divided into Layer 1 (i.e., a PHY layer), Layer 2, Layer 3 (e.g., an RRC layer), and anon-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting;

error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

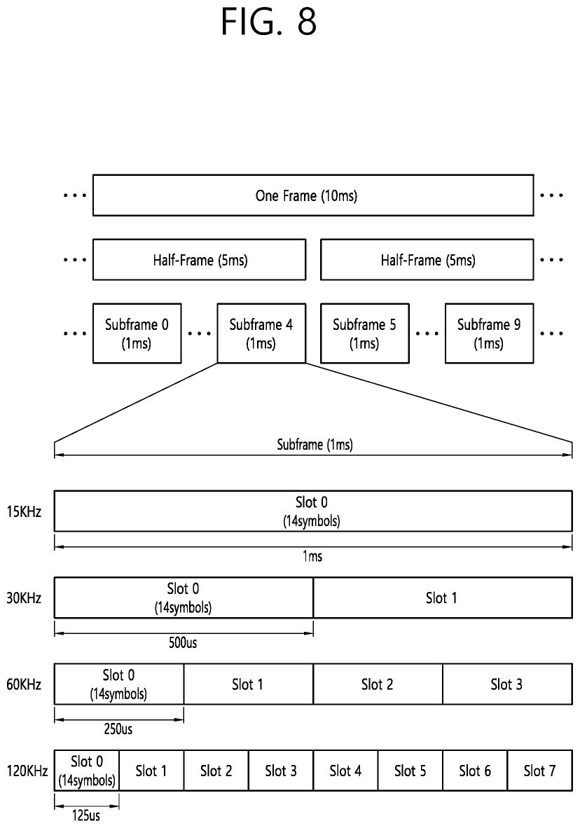

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has Tf=10 ms duration. Each frame is divided into two half-frames, where each of the half-frames has 5 ms duration. Each half-frame consists of 5 subframes, where the duration Tsf per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2u*15 kHz.

Table 1 shows the number of OFDM symbols per slot Nslotsymb, the number of slots per frame Nframe,uslot, and the number of slots per subframe Nsubframe,uslot for the normal CP, according to the subcarrier spacing Δf=2u*15 kHz.

TABLE 1

| u | Nslotsymb | Nframe,uslot | Nsubframe,uslot |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot Nslotsymb, the number of slots per frame Nframe,uslot, and the number of slots per subframe Nsubframe,uslot for the extended CP, according to the subcarrier spacing Δf=2u*15 kHz.

TABLE 2

| u | Nslotsymb | Nframe,uslot | Nsubframe,uslot |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of Nsize,ugrid,x*NRBsc subcarriers and Nsubframe,usymb OFDM symbols is defined, starting at common resource block (CRB) Nstart,ugrid indicated by higher-layer signaling (e.g., RRC signaling), where Nsize,ugrid,x is the number of resource blocks (RBs) in the resource grid and the subscript x is DL for downlink and UL for uplink. NRBsc is the number of subcarriers per RB. In the 3GPP based wireless communication system, NRBsc is 12 generally. There is one resource grid for a given antenna port p, subcarrier spacing configuration u, and transmission direction (DL or UL). The carrier bandwidth Nsize,ugrid for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index 1 representing a symbol location relative to a reference point in the time domain. In the 3GPP based wireless communication system, an RB is defined by 12 consecutive subcarriers in the frequency domain.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to NsizeBWP,i-1, where i is the number of the bandwidth part. The relation between the physical resource block nPRB in the bandwidth part i and the common resource block nCRB is as follows: nPRB=nCRB+NsizeBWP,i, where NsizeBWP,i is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FR1 may mean “sub 6 GHz range”, FR2 may mean “above 6 GHz range,” and may be referred to as millimeter wave (mmW).

TABLE 3

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 4

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC CONNECTED not configured with CA/DC, there is only one serving cell comprised of the PCell. For a UE in RRC CONNECTED configured with CA/DC, the term “serving cells” is used to denote the set of cells comprised of the SpCell(s) and all SCells. In DC, two MAC entities are configured in a UE: one for the MCG and one for the SCG.

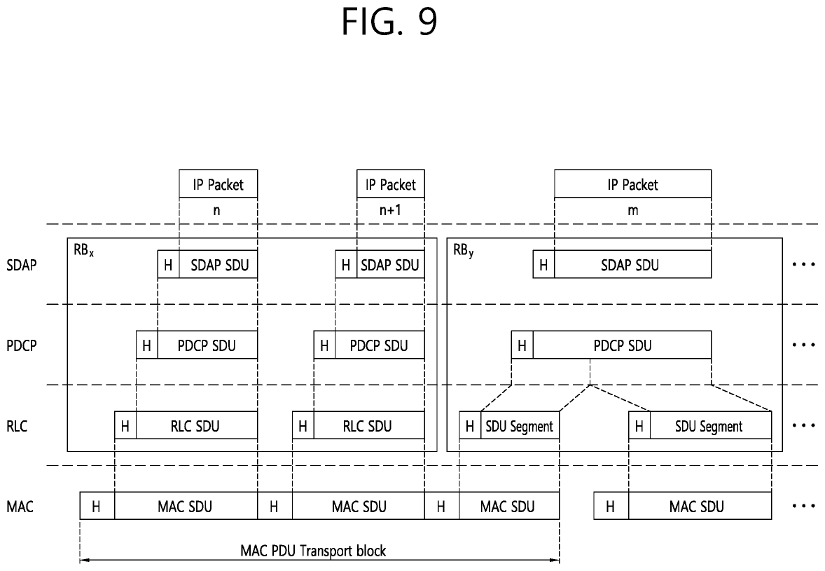

FIG. 9 shows a data flow example in the 3GPP NR system to which implementations of the present disclosure is applied.

Referring to FIG. 9, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels PUSCH and PRACH, respectively, and the downlink transport channels DL-SCH, BCH and PCH are mapped to PDSCH, PBCH and PDSCH, respectively. In the PHY layer, uplink control information (UCI) is mapped to PUCCH, and downlink control information (DCI) is mapped to PDCCH. A MAC PDU related to UL-SCH is transmitted by a UE via a PUSCH based on an UL grant, and a MAC PDU related to DL-SCH is transmitted by a BS via a PDSCH based on a DL assignment.

Hereinafter, random access procedure is described. It may be referred to as Section 5.1 of 3GPP TS 38.321 v15.6.0.

The Random Access procedure is initiated by a PDCCH order, by the MAC sublayer itself or by the RRC sublayer. Random Access procedure on an SCell shall only be initiated by a PDCCH order. If a MAC entity receives a PDCCH transmission consistent with a PDCCH order masked with its C-RNTI, and for a specific Serving Cell, the MAC entity shall initiate a Random Access procedure on this Serving Cell. For Random Access on the SpCell a PDCCH order or RRC optionally indicate the ra-PreambleIndex and the ra-PRACH-MaskIndex, except for NB-IoT where the subcarrier index is indicated; and for Random Access on an SCell, the PDCCH order indicates the ra-PreambleIndex with a value different from 000000 and the ra-PRACH-MaskIndex. For the pTAG preamble transmission on PRACH and reception of a PDCCH order are only supported for SpCell. If the UE is an NB-IoT UE, the Random Access procedure is performed on the anchor carrier or one of the non-anchor carriers for which PRACH resource has been configured in system information.

The following information for related Serving Cell is assumed to be available before the procedure can be initiated for NB-IoT UEs, BL UEs or UEs in enhanced coverage:

>if the UE is a BL UE or a UE in enhanced coverage:

>>the available set of PRACH resources associated with each enhanced coverage level supported in the Serving Cell for the transmission of the Random Access Preamble, prach-ConfigIndex.

>>for EDT, the available set of PRACH resources associated with EDT for each enhanced coverage level supported in the Serving Cell for the transmission of the Random Access Preamble, prach-ConfigIndex.

The random-access procedure shall be performed as follows:

>if the UE is an NB-IoT UE, a BL UE or a UE in enhanced coverage:

>>instruct the physical layer to transmit a preamble with the number of repetitions required for preamble transmission corresponding to the selected preamble group (i.e., numRepetitionPerPreambleAttempt) using the selected PRACH corresponding to the selected enhanced coverage level, corresponding RA-RNTI, preamble index or for NB-IoT subcarrier index, and PREAMBLE_RECEIVED_TARGET_POWER.

Meanwhile, a wireless device may receive downlink (DL) via RRC message during random access procedure. A wireless device may receive the DL data by mobile terminated (MT) early data transmission (EDT) procedure. For example, the DL data may be included in the second message (Message-2) in random access procedure. For other example, the DL data may be included in the fourth message (Message-4) in random access procedure.

In Message-2 (Msg2) based MT EDT, at least one dedicated random access (RA) resource is provided to a wireless device via the paging message. The purpose of the dedicated RA resource is to distinguish a target wireless device transmitting RA preamble using the dedicated RA resource.

The target wireless device for MT EDT may transmit RA preamble by using the dedicated RA resource. Upon receiving the RA preamble based on the dedicated RA resource, the network may transmit DL user data to the target wireless device via Msg2.

On the other hand, a wireless may not successfully transmit a RA preamble to the network in the first attempt. If the wireless device supports coverage enhancement (CE) mode and the preamble transmission is failed, the wireless device may perform CE operations.

For example, the wireless device may increase the CE level of the wireless device to the next CE level. If the wireless device is in the maximum CE level, the wireless device may declare RA failure. For example, upon increasing the CE level, the wireless device may perform power ramping. For example, upon increasing the CE level, the wireless device may perform preamble retransmission in the increased CE level. For example, the wireless device may retransmit RA preamble with ramped power.

For preamble retransmission, the wireless device should transmit preamble using the associated RA resource with the current CE level. Since wireless devices in enhanced coverage are derived from the associated RA resource. For example, time resource, frequency resources and/or repetition factor, used by wireless devices in the enhanced coverage, for random access response messages (for example, Msg2) may be derived from the used RA resource.

In this case, if dedicated RA resources for MT EDT are provided in a paging message per each CE level, the network may require lots of resources for the dedicated RA resources. Then, the network resource could be wasteful because of the increased paging message volume and assigning several RA resources to a single wireless device.

Therefore, studies for random access fallback procedure related to MT EDT in a wireless communication system are required.

Hereinafter, a method for random access fallback procedure related to MT EDT in a wireless communication system, according to some embodiments of the present disclosure, will be described with reference to the following drawings.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings. Herein, a wireless device may be referred to as a user equipment (UE).

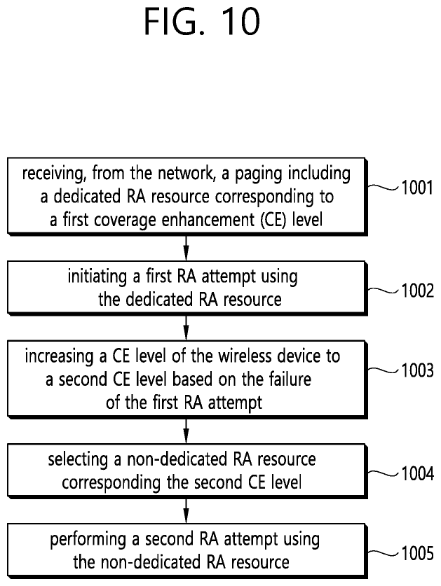

FIG. 10 shows an example of a method for random access fallback procedure related to MT EDT in a wireless communication system, according to some embodiments of the present disclosure.

In particular, FIG. 10 shows an example of a method performed by a wireless device. In this example, a wireless device may receive, from a network, connection release message. The wireless device may enter idle state or inactive state upon receiving the connection release message. Upon receiving a paging in the idle state or inactive state, the wireless device may perform a random access (RA) procedure. Specifically, the wireless device may perform several RA attempts in the RA procedure.

For example, if the first RA attempt using the dedicated RA resource is successful, the wireless device may receive, from the network, DL data via MT EDT procedure. For other example, if the first RA attempt using the dedicated RA resource is successful, the wireless device may establish an RRC connection with the network. In other words, the wireless device may perform 2-step RA procedure.

Otherwise, if the other RA attempt using the non-dedicated RA resource is successful, the wireless device may establish an RRC connection with the network. In other words, the wireless device may perform 4-step RA procedure.

When all of the RA attempts are failed, the wireless device may declare the RA failure. According to some embodiments of the present disclosure, a wireless device may receive, from the network, non-dedicated RA resources while in connected state before receiving the connection release message. For example, a wireless device may receive the non-dedicated RA resources via system information and/or dedicated RRC signalling. For example, each of the non-dedicated RA resources are corresponded to each of CE levels.

Referring to FIG. 10, in step 1001, a wireless device may receive, from the network, a paging including a dedicated RA resource corresponding to a first coverage enhancement (CE) level.

For example, the paging may include MT EDT information. The MT EDT information may include a number of the preamble transmissions in a single RA attempt. For example, the number of the preamble transmissions in a single RA attempt may be configured by the network.

In step 1002, a wireless device may initiate a first RA attempt using the dedicated RA resource. For example, the first RA attempt may be a contention free random access using the dedicated RA resource.

For example, the wireless device may perform several preamble transmissions in the first RA attempt. For example, the number of the preamble transmissions in the first RA attempt may be included the paging.

According to some embodiments of the present disclosure, a wireless device may determine whether the first RA attempt is successful or not.

For example, the UE may determine that the first RA attempt is failed based on that the UE does not receive an RA response or a message-2 in response to the several preamble transmissions in the first RA attempt.

For example, the UE may determine that the first RA attempt is failed based on that the UE does not receive, from the network, an RA response or a message-2 in response to the first RA attempt within a RA response window or a message-2 reception window.

For example, the UE may determine that the first RA attempt is failed based on that an RA response or a message-2 in response to the first RA attempt does not include an identifier (ID) of the wireless device.

In step 1003, a wireless device may increase a CE level of the wireless device to a second CE level based on failure of the first RA attempt. For example, the wireless device may increase the CE level upon determining that the first RA attempt is failed.

For example, the second CE level may be increased by 1 from the first CE level. In other words, the wireless device may increase the CE level or the wireless device by 1 from the first CE level. For example, the first CE level may be configured as a CE level 0 and the second CE level may be configured as CE level 1.

According to some embodiments of the present disclosure, the wireless device may decide the second CE level upon detecting the failure of the first RA attempt.

For example, the wireless device may decide the second CE level based on Reference Signal Received Power (RSRP) measurement.

For other example, the wireless device may decide the second CE level based on number of preamble transmissions in the first RA attempt. For example, the number of the preamble transmissions may be included in the paging.

For example, if the wireless device transmits more preambles in the first RA attempt, the wireless device may increase the second CE level higher. For example, if the number of the preamble transmissions in the first RA attempt more than a threshold value, the second CE level may be increased by an offset from the first CE level.

In step 1004, a wireless device may select a non-dedicated RA resource corresponding the second CE level.

For example, a wireless device may select the non-dedicated RA resource corresponding to the second CE level from the non-dedicated RA resources received via the system information and/or the dedicated RRC signalling.

In step 1005, a wireless device may perform a second RA attempt using the non-dedicated RA resource. For example, the second RA attempt may be contention based random access using the non-dedicated resource.

When the wireless device determines that the second RA attempt is failed, the wireless device may increase the CE level of the wireless device and select another non-dedicated RA resource corresponding to the CE level of the wireless device. Then the wireless device may perform the next RA attempt using the other non-dedicated RA resource.

When the wireless device determines that the RA attempt is failed in the maximum CE level, the wireless device may declare the random access failure.

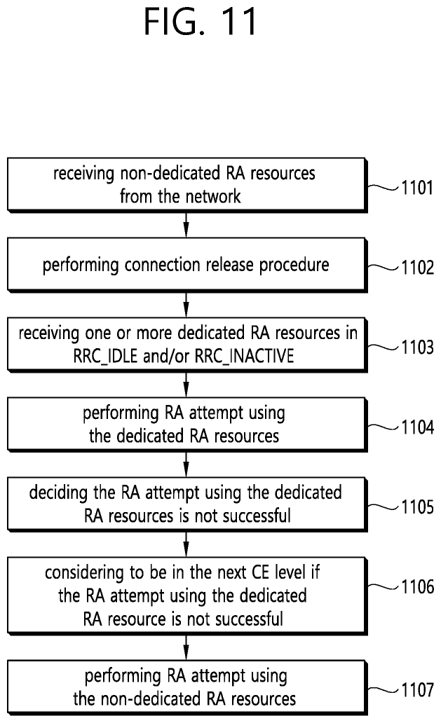

FIG. 11 shows an example of a method for random access fallback procedure related to MT EDT in a wireless communication system, according to some embodiments of the present disclosure.

In particular, in FIG. 11, a UE may perform several random access (RA) attempts in a RA procedure. A UE may perform RA attempt using the non-dedicated RA resource corresponding to an enhanced coverage level, when a RA attempt performed using the dedicated RA resource is not successful.

For example, the enhanced coverage level may be a coverage level determined at the time when the number of RA preamble transmission using the dedicated RA resource reaches the maximum value.

Referring to FIG. 11, in step 1101, the UE may receive non-dedicated RA resources from the network.

For example, the non-dedicated RA resources may be for coverage enhancement.

For example, each of the non-dedicated RA resources may be associated with each enhanced coverage level supported in the cell for the RA preamble transmission.

For example, the UE may receive the non-dedicated RA resources via system information (for example, prach-ConfigIndex).

For example, the UE may receive the non-dedicated RA resources via system information or dedicated RRC signalling. For example, the UE may receive the non-dedicated RA resources when a UE requests the resources.

In step 1102, the UE may perform connection release procedure. The UE may receive connection release message (for example, RRCRelease message) from the network. Upon receiving the connection release message, the UE may enter idle sate (for example, RRC_IDLE) and/or inactive state (for example, RRC_INACTIVE).

In step 1103, the UE may receive one or more dedicated RA resources in RRC_IDLE and/or RRC_INACTIVE.

For example, the UE may receive the dedicated RA resources via paging in RRC_IDLE or RRC_INACTIVE.

For example, the UE may receive one or more non-dedicated RA resources in RRC_IDLE or RRC_INACTIVE.

For example, the dedicated RA resources may be for mobile-terminated (MT) early data transmission (EDT).

In step 1104, the UE may perform RA attempt using the dedicated RA resources. For example, the UE may perform the first RA attempt using the dedicated RA resources.

For example, the UE may not decide CE level of the UE based on the RSRP measurement. For example, the UE may consider itself to be in a normal coverage (or CE level 0), if the explicit CE level is not indicated from the network. For example, the UE may consider itself to be in a normal coverage (or CE level 0), if the number of repetitions or the number of the RA attempts is not indicated from the network.

According to some embodiments of the present disclosure, the UE may perform several preamble transmissions in a single attempt using the dedicated RA resources. For example, the number of the preamble transmissions in a single attempt may be configured by a network. For example, the number of the preamble transmissions in a single attempt may be included in the paging.

For example, the UE may consider that the RA attempt is not successful, if the number of preamble transmissions reaches the pre-configured value (for example, maximum value).

In step 1105, the UE may decide the RA attempt using the dedicated RA resources is not successful.

For example, the UE may decide that the RA attempt using the dedicated RA resource is not successful, when the UE does not receive RA Response.

For example, the UE may decide that the RA attempt using the dedicated RA resource is not successful, when the UE does not receive message-2 (Msg2) for MT EDT.

For example, the UE may decide that the RA attempt using the dedicated RA resource is not successful, when the UE does not receive RA Response within the RA Response window.

For example, the UE may decide that the RA attempt using the dedicated RA resource is not successful, when the UE does not receive message-2 within the reception window.

For example, the UE may decide that the RA attempt using the dedicated RA resource is not successful, when the UE does not receive MT EDT information in RA Response.

For example, the UE may decide that the RA attempt using the dedicated RA resource is not successful, when the RA Response or message-2 does not contain the identifier mapped to the RA preamble transmitted in step 1104.

In step 1106, the UE may consider to be in the next CE level if the RA attempt using the dedicated RA resource is not successful.

For example, the UE may set the CE level value increased by 1.

For example, the UE may decide the CE level based on MT EDT information (for example, the number of the RA attempts or the number of the repetitions) provided in paging.

For example, the UE may decide the CE level based on the RSRP measurement if the RA attempt using the dedicated RA resource is not successful.

In step 1107, the UE may perform RA attempt using the non-dedicated RA resources. For example, the UE may receive the non-dedicated RA resources in step 1101.

For example, the UE may perform the second RA attempt using the non-dedicated RA resources, after performing the first RA attempt using the dedicated RA resources in step 1104.

According to some embodiments of the present disclosure, the UE may select a RA resource among the non-dedicated RA resources based on the next CE level. Then, the UE may perform the second RA attempt using the selected non-dedicated RA resource.

For example, the UE may select a RA resource associated with the current CE level based on the PRACH configuration information provided in system information.

For example, the UE may select a RA resource associated with the current CE level based on the PRACH configuration information provided via dedicated RRC signalling.

Hereinafter, an example of a scenatio according to some embodiments of the present disclosure will be described.

In the example of the scenario, the UE may enter RRC_IDLE and/or RRC_INACTIVE upon receiving connection release message.

The UE may receive dedicated RA resource corresponding to CE level 1 via paging.

The UE may initiate RA procedure using the dedicated RA resource. For example, the UE may perform the first RA attempt using the dedicated RA resource.

The UE may transmit RA preamble using the dedicated RA resource 3 times. For example, the number of preamble transmissions in a single RA attempt may be configured as 3.

The UE may not receive Msg2 for MT EDT until transmitting RA preamble 3 times in the first RA attempt.

The UE may decide CE level of the UE based on the RSRP measurement. For example, the UE may decide the current CE level as 3.

The UE may select a non-dedicated RA resource mapped to CE level 3 based on the configuration received via system information.

The UE may continue the RA procedure using the selected non-dedicated RA resource. For example, the UE may perform the second RA attempt using the selected non-dedicated RA resource.

The UE may decide that the RA procedure is failed, if the preamble transmission is not successful even in the maximum CE level. For example, the maximum CE level (for example, CE level 3) may be configured by a network.

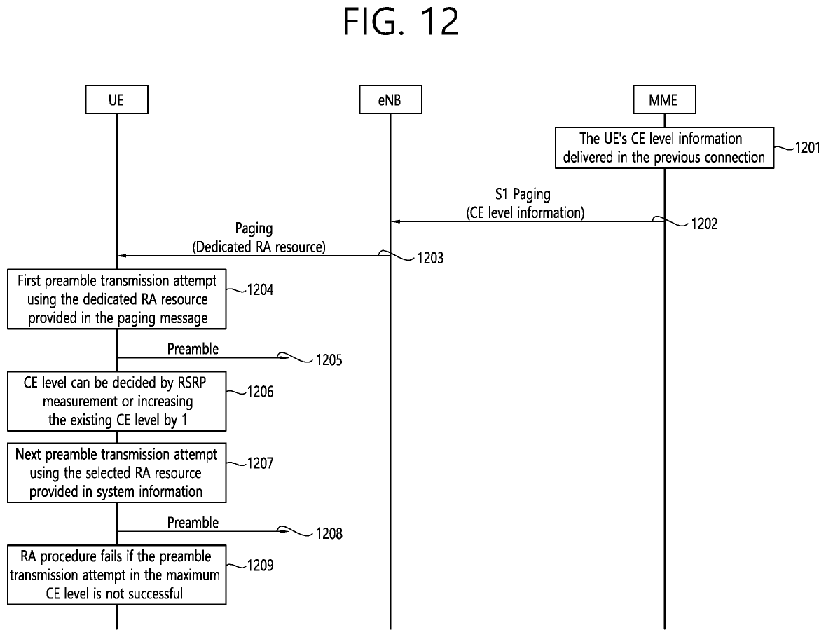

FIG. 12 shows a diagram of a method for random access fallback procedure related to MT EDT in a wireless communication system, according to some embodiments of the present disclosure.

In step 1201, the core network node (for example, MME) may generate CE level information of a UE. For example, the MME may store the CE level information of the UE which is delivered in the previous connection.

In step 1202, the MME may transmit, to an eNB or a gNB, Si paging including the CE level information.

In step 1203, the eNB or gNB may transmit, to the UE, a paging including dedicated RA resources.

In step 1204, the UE may perform the first random access (RA) attempt using the dedicated RA resource provided in the paging message.

For example, in step 1205, the UE may transmit the preamble several times in the first RA attempt. If the UE may not receive the RA response from the network in response to the first RA attempt, the UE may determine that the first RA attempt is failed.

In step 1206, the UE may decide CE level of the UE. For example, the CE level could be decided by RSRP measurement. For other example, the UE may increase the CE level by 1 from the existing CE level.

In this step, the UE may select another non-dedicated RA resource based on the updated CE level. For example, the UE may select the other non-dedicated RA resource among the non-dedicated RA resources provided from the network. For example, the non-dedicated RA resources may be provided via the system information and/or the dedicated RRC signalling.

In step 1207, the UE may perform the next RA attempt using the selected RA resource.

For example, in step 1208, the UE may transmit the preamble several times using the selected RA resource in the next RA attempt.

If the UE does not receive the RA response from the network, the UE may repeat step 1206 to 1208 until the CE level of the UE becomes to the maximum CE level.

For example, in step 1209, the UE may determine that the RA procedure is failed if the RA attempt in the maximum CE level is not successful. In this case, the UE may declare the RA failure.

Hereinafter, an example of a procedure for random access fallback procedure related to MT EDT in a wireless communication system, according to some embodiments of the present disclosure, is described.

According to some embodiments, if no Random Access Response or, for NB-IoT UEs, BL UEs or UEs in enhanced coverage for mode B operation, no PDCCH scheduling Random Access Response is received within the RA Response window, or if none of all received Random Access Responses contains a Random Access Preamble identifier corresponding to the transmitted Random Access Preamble, the Random Access Response reception is considered not successful and the MAC entity shall:

If the UE is an NB-IoT UE, a BL UE or a UE in enhanced coverage:

>increment PREAMBLE_TRANSMISSION_COUNTER_CE by 1;

>if PREAMBLE_TRANSMISSION_COUNTER_CE=maxNumPreambleAttemptCE for the corresponding enhanced coverage level+1:

>>reset PREAMBLE_TRANSMISSION_COUNTER_CE;

>>consider to be in the next enhanced coverage level, if it is supported by the Serving Cell and the UE, otherwise stay in the current enhanced coverage level;

>>if the UE is an NB-IoT UE:

>>>if the Random Access Procedure was initiated by a PDCCH order:

>>>select the PRACH resource in the list of UL carriers providing a PRACH resource for the selected enhanced coverage level for which the carrier index is equal to ((Carrier Indication from the PDCCH order) modulo (Number of PRACH resources in the selected enhanced coverage));

>>>consider the selected PRACH resource as explicitly signalled;

>>if the Random Access Procedure was initiated by MT EDT:

>>>discard explicitly signalled ra-PreambleIndex and ra-PRACH-MaskIndex; (or new parameters defined for CF PRACH in paging)

>proceed to the selection of a Random Access Resource.

Hereinafter, an apparatus for random access fallback procedure related to MT EDT in a wireless communication system, according to some embodiments of the present disclosure, will be described. Herein, the apparatus may be a wireless device (100 or 200) in FIGS. 2, 3, and 5.

For example, a wireless device may perform methods described in FIGS. 10 to 12. The detailed description overlapping with the above-described contents could be simplified or omitted.

Referring to FIG. 5, a wireless device 100 may include a processor 102, a memory 104, and a transceiver 106.

According to some embodiments of the present disclosure, the processor 102 may be configured to be coupled operably with the memory 104 and the transceiver 106.

The processor 102 may be configured to control the transceiver 106 to receive, from a network, connection release message. The processor 102 may be configured to enter idle state or inactive state upon receiving the connection release message. The processor 102 may be configured to control the transceiver 106 to receive, from the network, a paging including a dedicated random access (RA) resource corresponding to a first coverage enhancement (CE) level. The processor 102 may be configured to initiate a first RA attempt using the dedicated RA resource. The processor 102 may be configured to increase CE level of the wireless device to a second CE level based on failure of the first RA attempt. The processor 102 may be configured to select a non-dedicated RA resource corresponding the second CE level. The processor 102 may be configured to perform a second RA attempt using the non-dedicated RA resource.

For example, the processor 102 may be configured to control the transceiver 106 to receive, from the network, non-dedicated RA resources. For example, each of the non-dedicated RA resources may be corresponded to each of CE levels.

For example, the non-dedicated RA resources may be received via system information and/or dedicated RRC signalling.

According to some embodiments of the present disclosure, the processor 102 may be configured to determine whether the first RA attempt is successful or not.

For example, the first RA attempt may be determined to be failed based on that the UE does not receive, from the network, an RA response or a message-2 in response to the first RA attempt within a RA response window or a message-2 reception window.

For example, the first RA attempt may be determined to be failed based on that an RA response or a message-2 in response to the first RA attempt does not include an identifier of the wireless device.

According to some embodiments of the present disclosure, the second CE level may be increased by 1 from the first CE level.

According to some embodiments of the present disclosure, the processor 102 may be configured to decide the second CE level based on Reference Signal Received Power (RSRP) measurement.

According to some embodiments of the present disclosure, the processor 102 may be configured to decide the second CE level based on number of preamble transmissions in the first RA attempt.

According to some embodiments of the present disclosure, the wireless device may be in communication with at least one of a user equipment, a network, or an autonomous vehicle other than the wireless device.

Hereinafter, a processor for a wireless device for random access fallback procedure related to MT EDT in a wireless communication system, according to some embodiments of the present disclosure, will be described.

The processor may be configured to control the wireless device to receive, from a network, connection release message. The processor may be configured to control the wireless device to enter idle state or inactive state upon receiving the connection release message. The processor may be configured to control the wireless device to receive, from the network, a paging including a dedicated random access (RA) resource corresponding to a first coverage enhancement (CE) level. The processor may be configured to control the wireless device to initiate a first RA attempt using the dedicated RA resource. The processor may be configured to control the wireless device to increase a CE level of the wireless device to a second CE level based on the failure of the first RA attempt. The processor may be configured to control the wireless device to select a non-dedicated RA resource corresponding the second CE level. The processor may be configured to control the wireless device to perform a second RA attempt using the non-dedicated RA resource.

For example, the processor may be configured to control the wireless device to receive, from the network, non-dedicated RA resources. For example, each of the non-dedicated RA resources may be corresponded to each of CE levels.

For example, the non-dedicated RA resources may be received via system information and/or dedicated RRC signalling.

According to some embodiments of the present disclosure, the processor may be configured to control the wireless device to determine whether the first RA attempt is successful or not.

For example, the first RA attempt may be determined to be failed based on that the UE does not receive, from the network, an RA response or a message-2 in response to the first RA attempt within a RA response window or a message-2 reception window.

For example, the first RA attempt may be determined to be failed based on that an RA response or a message-2 in response to the first RA attempt does not include an identifier of the wireless device.

According to some embodiments of the present disclosure, the second CE level may be increased by 1 from the first CE level.

According to some embodiments of the present disclosure, the processor may be configured to control the wireless device to decide the second CE level based on Reference Signal Received Power (RSRP) measurement.

According to some embodiments of the present disclosure, the processor may be configured to control the wireless device to decide the second CE level based on number of preamble transmissions in the first RA attempt.

According to some embodiments of the present disclosure, the wireless device may be in communication with at least one of a user equipment, a network, or an autonomous vehicle other than the wireless device.

Hereinafter, a non-transitory computer-readable medium has stored thereon a plurality of instructions for random access fallback procedure related to MT EDT in a wireless communication system, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions. The stored a plurality of instructions may be executed by a processor of a wireless device.

The stored a plurality of instructions may cause the wireless device to receive, from a network, connection release message. The stored a plurality of instructions may cause the wireless device to enter idle state or inactive state upon receiving the connection release message. The stored a plurality of instructions may cause the wireless device to receive, from the network, a paging including a dedicated random access (RA) resource corresponding to a first coverage enhancement (CE) level. The stored a plurality of instructions may cause the wireless device to initiate a first RA attempt using the dedicated RA resource. The stored a plurality of instructions may cause the wireless device to increase a CE level of the wireless device to a second CE level based on the failure of the first RA attempt. The stored a plurality of instructions may cause the wireless device to select a non-dedicated RA resource corresponding the second CE level. The stored a plurality of instructions may cause the wireless device to perform a second RA attempt using the non-dedicated RA resource.

For example, the stored a plurality of instructions may cause the wireless device to receive, from the network, non-dedicated RA resources. For example, each of the non-dedicated RA resources may be corresponded to each of CE levels.

For example, the non-dedicated RA resources may be received via system information and/or dedicated RRC signalling.

According to some embodiments of the present disclosure, the stored a plurality of instructions may cause the wireless device to determine whether the first RA attempt is successful or not.

For example, the first RA attempt may be determined to be failed based on that the UE does not receive, from the network, an RA response or a message-2 in response to the first RA attempt within a RA response window or a message-2 reception window.

For example, the first RA attempt may be determined to be failed based on that an RA response or a message-2 in response to the first RA attempt does not include an identifier of the wireless device.

According to some embodiments of the present disclosure, the second CE level may be increased by 1 from the first CE level.

According to some embodiments of the present disclosure, the stored a plurality of instructions may cause the wireless device to decide the second CE level based on Reference Signal Received Power (RSRP) measurement.

According to some embodiments of the present disclosure, the stored a plurality of instructions may cause the wireless device to decide the second CE level based on number of preamble transmissions in the first RA attempt.

According to some embodiments of the present disclosure, the wireless device may be in communication with at least one of a user equipment, a network, or an autonomous vehicle other than the wireless device.

Hereinafter, a method for random access fallback procedure related to MT EDT performed by a base station (BS) in a wireless communication system, according to some embodiments of the present disclosure, will be described.

The method may include receiving, by the BS from a Mobility Management Entity (MME), a S1 Paging including CE level information.

The method may include transmitting, by the BS, to the UE, a Paging including dedicated Random Access (RA) resource.

Hereinafter, a base station (BS) for random access fallback procedure related to MT EDT in a wireless communication system, according to some embodiments of the present disclosure, will be described.

ABS may receive, from a Mobility Management Entity (MME), a S1 Paging including CE level information.

A BS may transmit, to the UE, a Paging including dedicated Random Access (RA) resource.

The present disclosure can have various advantageous effects.

According to some embodiments of the present disclosure, a wireless device could perform random access fallback procedure efficiently.

For example, a wireless device may save resource for random access fallback procedure, when a wireless device fails to transmit a preamble to the network while in message-2 based MT EDT procedure.

For example, a wireless device may save resource for supporting coverage enhancement (CE) mode by assigning one dedicated random access resource to the wireless device.

In other words, by assigning one dedicated PRACH resource to a UE supporting CE mode, the wasteful use of dedicated PRACH resource could be avoided.

For example, a wireless device may increase reliability of MT EDT procedure by continuing the procedure using contention based random access (CBRA) procedure, when contention free random access (CFRA) procedure is not successful.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

What is claimed is:

1. A method performed by a wireless device in a wireless communication system, the method comprising,
receiving, from a network, connection release message;
entering idle state or inactive state upon receiving the connection release message;
receiving, from the network, a paging including a dedicated random access (RA) resource corresponding to a first coverage enhancement (CE) level;
initiating a first RA attempt using the dedicated RA resource;
increasing a CE level of the wireless device to a second CE level based on failure of the first RA attempt;
selecting a non-dedicated RA resource corresponding the second CE level; and
performing a second RA attempt using the non-dedicated RA resource.

2. The method of claim 1, wherein the method further comprises,
receiving, from the network, non-dedicated RA resources, wherein each of the non-dedicated RA resources are corresponded to each of CE levels.

3. The method of claim 2, wherein the non-dedicated RA resources are received via system information and/or dedicated RRC signalling.

4. The method of claim 1, wherein the method further comprises,
determining whether the first RA attempt is successful or not.

5. The method of claim 4, wherein the first RA attempt is determined to be failed based on that the UE does not receive, from the network, an RA response or a message-2 in response to the first RA attempt within a RA response window or a message-2 reception window.

6. The method of claim 4, wherein the first RA attempt is determined to be failed based on that an RA response or a message-2 in response to the first RA attempt does not include an identifier of the wireless device.

7. The method of claim 1, wherein the second CE level is increased by 1 from the first CE level.

8. The method of claim 1, wherein the method further comprises,
deciding the second CE level based on Reference Signal Received Power (RSRP) measurement.

9. The method of claim 1, wherein the method further comprises,
deciding the second CE level based on number of preamble transmissions in the first RA attempt.

10. The method of claim 1, wherein the wireless device is in communication with at least one of a user equipment, a network, or an autonomous vehicle other than the wireless device.

11. A wireless device in a wireless communication system comprising:
a transceiver;
a memory; and
at least one processor operatively coupled to the transceiver and the memory, and configured to:
control the transceiver to receive, from a network, connection release message;
enter idle state or inactive state upon receiving the connection release message;
control the transceiver to receive, from the network, a paging including a dedicated random access (RA) resource corresponding to a first coverage enhancement (CE) level;
initiate a first RA attempt using the dedicated RA resource;
increase a CE level of the wireless device to a second CE level based on the failure of the first RA attempt;
select a non-dedicated RA resource corresponding the second CE level; and
perform a second RA attempt using the non-dedicated RA resource.

12. The wireless device of claim 11, wherein the second CE level is increased by 1 from the first CE level.

13. The wireless device of claim 11, wherein the at least one processor is further configured to decide the second CE level based on Reference Signal Received Power (RSRP) measurement.

14. The wireless device of claim 11, wherein the at least one processor is further configured to decide the second CE level based on number of preamble transmissions in the first RA attempt.

15. A processor for a wireless device in a wireless communication system, wherein the processor is configured to control the wireless device to perform operations comprising:
receiving, from a network, connection release message;
entering idle state or inactive state upon receiving the connection release message;
receiving, from the network, a paging including a dedicated random access (RA) resource corresponding to a first coverage enhancement (CE) level;
initiating a first RA attempt using the dedicated RA resource;
increasing a CE level of the wireless device to a second CE level based on failure of the first RA attempt;
selecting a non-dedicated RA resource corresponding the second CE level; and
performing a second RA attempt using the non-dedicated RA resource.
